(19) United States
(12) Patent Application Publication
(10) Pub. No.: US 2015/0212937 A1
(43) Pub. Date: Jul. 30, 2015

(54) STORAGE TRANSLATION LAYER

(71) Applicant: PI-CORAL, INC., San Jose, CA (US)

(72) Inventor: Donpaul C. Stephens, Houston, TX (US)

(21) Appl. No.: 14/426,609

(22) PCT Filed: Sep. 6, 2013
(86) PCT No.: PCT/US13/58644

§ 371 Date: Mar. 6, 2015

Related U.S. Application Data
(60) Provisional application No. 61/697,711, filed on Sep. 6, 2012.
(60) Provisional application No. 61/799,487, filed on Mar. 15, 2013.

(51) Int. Cl. G06F 12/02

(52) U.S. Cl. CPC G06F 12/0253; G06F 12/0246; G06F 2212/7205

(57) ABSTRACT

Method and systems for distributing the translation layer of storage media (such as NAND Flash or Storage Class Memory Storage) system across various storage system components are described herein. Non-limiting examples of storage system components include a Persistent Storage Device (PSD), a Storage Aggregation Controller (SAC), and a Storage Management Writer (SMW). The SMW may be configured to maintain a table of the logical address of each page it writes to a PSD via a SAC. The SAC may maintain the status of the validity of previously written pages with the SMW informing the SAC when any page is no longer valid. The PSD may handle device specific issues including error correction and block-level mapping for management of block-level failures and internal wear-leveling. The SAC may handle garbage collection of the physical pages within the PSDs it is managing, while the SMW may maintain the actual page-level tables.

### CROSS REFERENCE TO RELATED APPLICATIONS

This application claims the benefit of U.S. Provisional Application Nos. 61/697,711 filed on Sep. 6, 2012 and 61/799,487 filed on Mar. 15, 2013 the contents of which are incorporated by reference in their entirety as if fully set forth herein.

### BACKGROUND

One characteristic of storage media, such as NAND (not-and) flash and storage class memory (“The Media” or “storage media”), is that storage media typically have an erase-before-program architecture. In addition, conventional storage media may read and program (or “write”) in a unit size (sectors, pages or the like) that is significantly smaller than the erase unit size. For example, common read and program unit sizes may be 4 kilobytes, 8 kilobytes, 16 kilobytes, 32 kilobytes, and 64 kilobytes, while common erase unit sizes (or blocks) are on the order of typically 200 to 1000 times the read/program unit size. The flash translation layer (FTL) software system has been developed to handle the erase-before-program architecture of storage media, and the misalignment of read/program unit size versus erase unit size. However, management of the FTL according to conventional methods typically adds to the cost and complexity of storage systems. Accordingly, methods to effectively and efficiently use the FTL and associated functions may benefit the data storage industry.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a data storage system configured to implement a storage translation layer may include a plurality of persistent storage devices, each of the plurality of persistent storage devices comprising storage media configured to store a plurality of data access units and metadata, and a storage device controller configured to manage a plurality of storage blocks of the storage media at a storage block level, a plurality of storage aggregation controllers in operable communication with the plurality of persistent storage devices, the plurality of storage aggregation controllers being configured to maintain a validity of the plurality of data access units, and a storage management writer controller in operable communication with the plurality of storage aggregation controllers, the storage management writer controller being configured to access logical addresses of the plurality of data access units and data stored in the plurality of persistent storage devices, and maintain a map between the logical addresses and the data stored in the plurality of storage aggregation controllers.

### BRIEF DESCRIPTION OF THE DRAWINGS

FIG. 1 shows a Media Erase block and its components of N Pages and the M Logical Block Addresses within a single page

FIG. 2 depicts address mapping according to some embodiments.

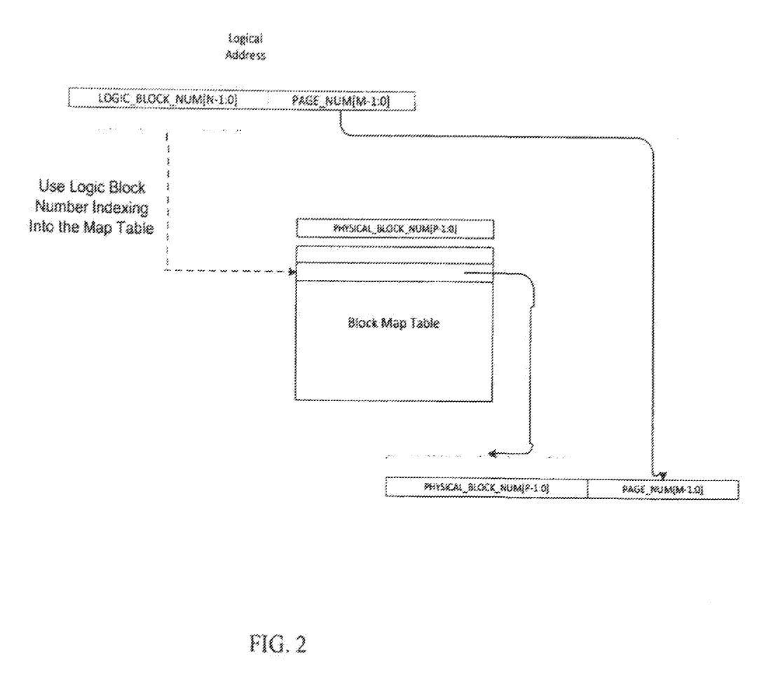

FIG. 3 depicts the mechanism for tracking valid pages inside the PSD by the SAC according to some embodiments.

FIG. 4. Depicts a typical write (also referred to as ‘program’) process

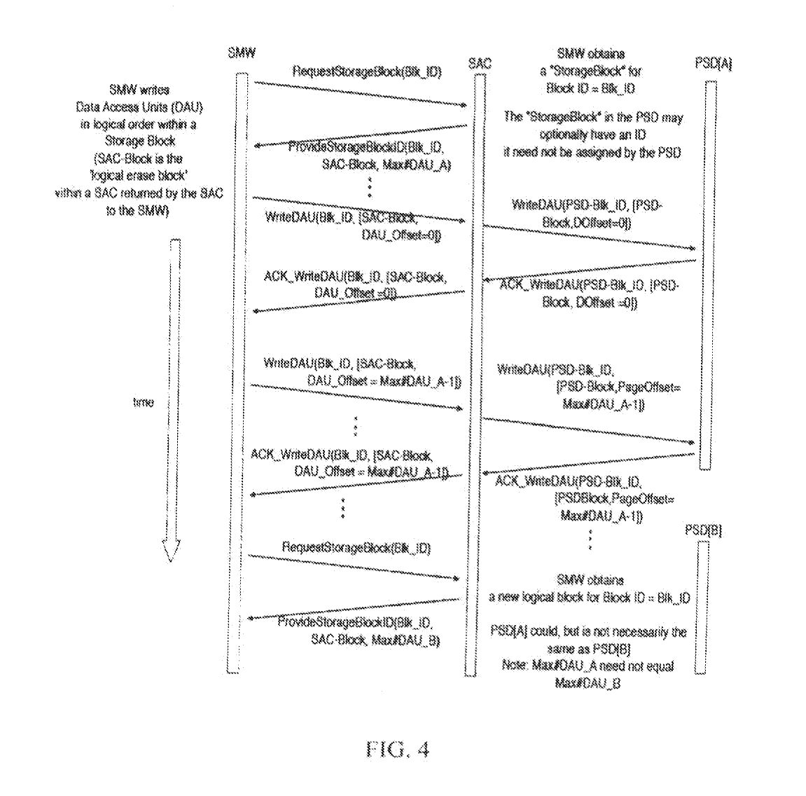

FIG. 5 depicts a mapping of the Storage Translation Layer from a SMW through SAC to the PSDs.

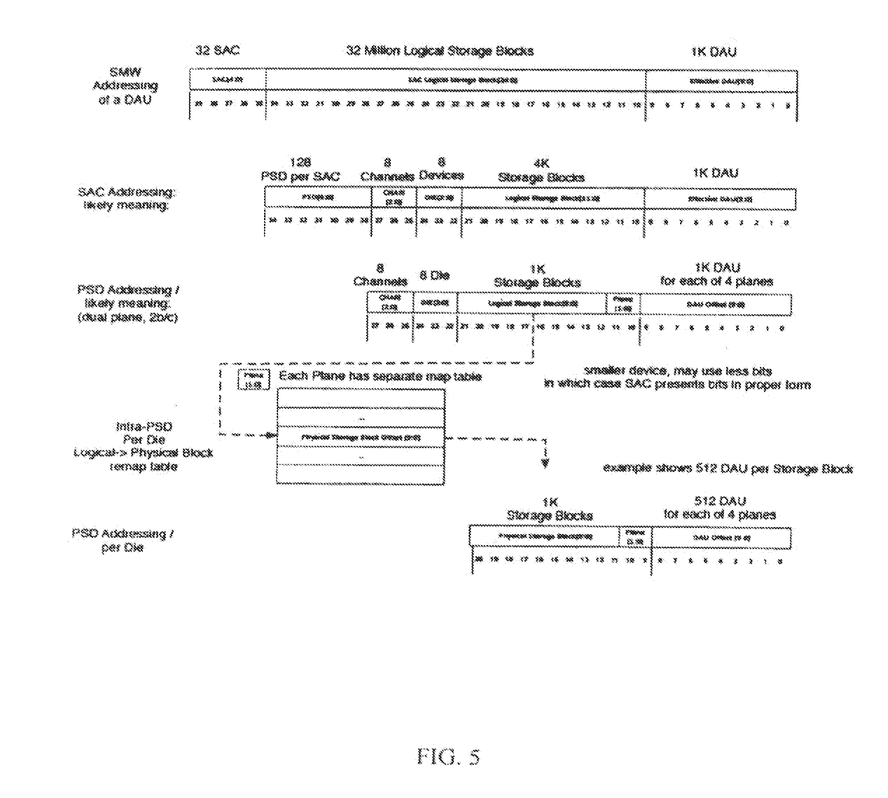

### DETAILED DESCRIPTION

An FTL may perform various functions. For example, an FTL may perform logical-to-physical (LTP) address mapping, which may generally involve the mapping of a logical system level address to a physical memory address. Another example function is power-off-recovery for the subsequent accessibility/recovery of stored data in the event of a power loss event. An additional example may involve wear-leveling in which program events may be placed such that the available pool of program units wears as evenly as possible to allow the majority of program units to reach the end of their useful life with a statistically predictable distribution. A further example includes garbage collection functions which may generally involve the separation and recovery of good data (for example, data that has temporal validity) from stale data (for example, data that no longer has temporal use) within an erase unit, and re-distribution of the good data back into the pool of available program units). FTL functions may typically be “contained” within the same functional unit as the storage media, which may be referred to as the storage device unit or solid state disk (SSD).

The performance of a FTL may involve various characteristics, such as read/program performance, system operation latency, average power per operation (read, program, erase) over time, efficacy of wear leveling, overprovisioning (for example, the amount of memory available for user data versus raw memory physically in the system), and the amount of memory required to store meta-data (“state information” or “state”), which may include LTP mapping information, free space information, and/or information for wear-leveling, garbage Collection, or the like.

The storage device unit cost typically associated with a given Flash Translation Layer implementation is directly proportional to the amount of memory required to store “hot” meta-data (typically stored in Random Access Memory (RAM)) and meta-data at rest (typically stored in The Media).

In order to reduce storage device unit cost, many cost sensitive consumer-class devices, and entry-level enterprise-class devices, manage The Media at only the erase unit level, as this minimizes the size of the meta-data required for maintaining state and consequently less RAM. Whereas, in performance sensitive enterprise-class devices, The Media is typically managed at the read/program unit size. In such applications, a meta-data item is typically required for each component of the managed size in the storage device incorporating The Media.

An additional property typically found in enterprise-class storage devices, relative to consumer-class devices, is that complexity and cost of the circuitry for controlling The Media, and the power consumed by said circuitry is greater such that it has a quantitatively significant cost difference both to manufacture and operate.

Furthermore, when incorporating the requirement that enterprise-class storage devices provide for more robust and reliable operation than consumer-class storage devices, the cost of adding error detection and correction information to the meta-data information further increases the cost and complexity of their manufacturing and operation.

The described technology generally relates to a method for distributing the translation layer of a NAND Flash or Storage Class Memory Storage (“The Media”) system across various storage system components. Non-limiting examples of storage system components include a Persistent Storage Device (PSD), a Storage Aggregation Controller (SAC), and a Storage Management Writer (SMW). The SMW may be configured to maintain a table of the logical address of each page it writes to a PSD via a SAC, with the writes of pages into each block being sequential until the block in the PSD can no longer accept further writes. The SAC may maintain the status of the validity of previously written pages with the SMW informing the SAC when any page is no longer valid. The SAC may determine when data in a block of a PSD needs to be “Garbage collected,” at which point the SAC may move data within or across PSDs it has access to and inform the SMW to update its record of the logical address the page is physically stored in. The PSD may handle device specific issues including error correction and block-level mapping for management of block-level failures and internal wear-leveling. The SAC may handle garbage collection of the physical pages within the PSDs it is managing, while the SMW may maintain the actual page-level tables.

In this manner, PSDs and the SAC may be configured to have minimal memory footprint and thus enable solutions that can be more cost and power-efficient than solutions that employ page-level mapping at lower-level controllers.

Embodiments described herein may define several distributed units that have historically been monolithically contained within a storage device unit: the Persistent Storage Device (PSD) that stores and manages erase units (and not read/program units) and contains The Media, the Storage Aggregation Controller (SAC) that coordinates temporal valid physical pages and manages Garbage Collection of read/program units within a collection of PSDs and the Storage Management Writers (SMWs) that maintain meta-data of the logical address of each read/program unit, writes to the PSDs via the SACs, assigns logical address for data units as they are written and informs the SACs when any logical unit is no longer valid and updates any changes in the logical address when Garbage Collection is performed by the SAC.

The system, method and apparatus described herein may provide Storage Translation Layer (STL) system software configured to, among other things, read/program unit-managed system across one or more SMWs wherein neither the SAC nor the PSD requires page-level meta-data and consequently allows PSDs with less RAM and less of The Media. Thereby providing quantitatively significant manufacturing and operational cost advantages.

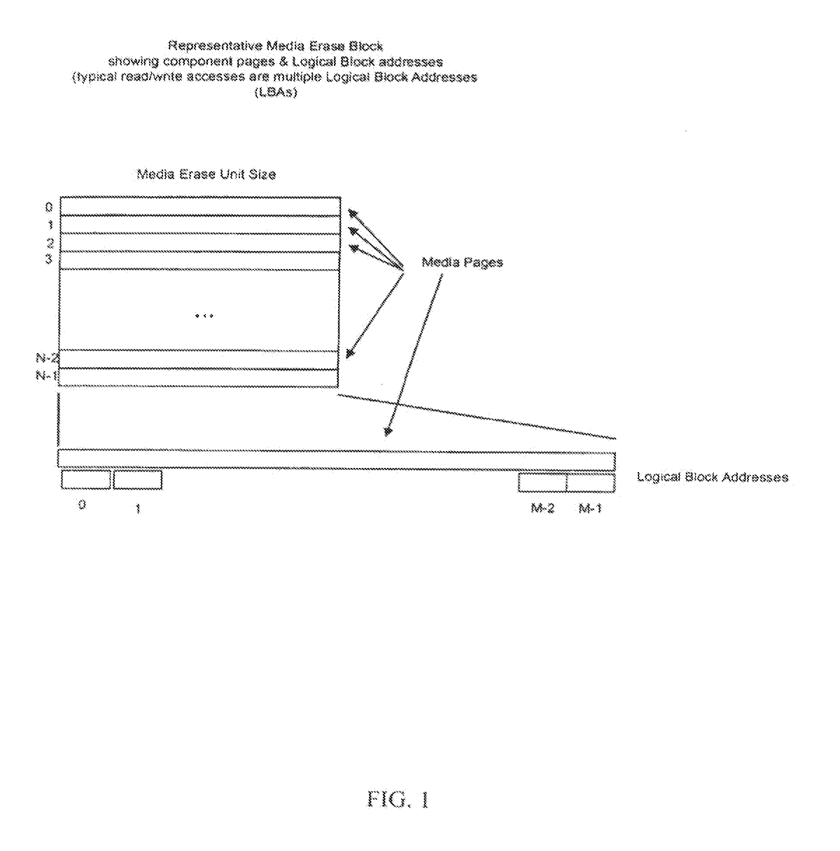

FIG. 1 shows a Media Erase block and its components of N Pages and the M Logical Block Addresses within a single page. A read/write unit is typically one or more Logical Block Addresses of a Media Page. As SSDs typically operate with a fixed size logical unit for their Flash Translation Layer internally, a Data Access Unit (DAU) may be that unit without loss of generality whether it is 512 bytes, 1 kilobytes, 4 kilobytes, or the like.

The Storage Translation Layer enables the “hot” meta-data which maintains the mapping of the Physical Address in which DAU are stored to be maintained not in the PSD, but instead on the SMW thereby enabling lower cost components in the PSD and SAC without loss of performance. Each PSD may independently manage its own erase-unit level mapping (also referred to as state or meta-data information). The PSD may manage blocks on The Media that is physically in one or multiple physical die (a physical unit of The Media).

If the PSD can maintain block mapping at the unit of a single die and the SAC maintains die level visibility into PSD operations, the SAC can manage accesses for each die by maintaining queues for operations at the SAC level where the system level attributes may be better understood than by each PSD in isolation.

The PSD does not need to maintain sub-erase-unit level mapping structures. For completeness, it may maintain state in order to detect a write into the middle of a block and internally perform a copy of all prior pages from a prior erase-unit to the new erase-unit for which the new write will be placed. The Storage Translation Layer may perform various functions and basic operations including writing, reading, and garbage collecting.

### Writing

In order to write data to PSDs controlled by a SMW, the SMW first requests a “Storage Block” (a unit of data storage that is programmed into The Media) from a SAC. For avoidance of doubt, one or more “Storage Blocks” may be provided by the SAC for any PSD and one or more PSDs may have “Storage Blocks” provided by the SAC to a given SMW.

The SAC may provide Storage Blocks to the SMW which are presently not in use for any valid data. The SAC may be responsible for performing Garbage Collection (described in more detail below) to obtain Storage Blocks which may not have valid data so they can be available for new writes.

In some embodiments, the PSD may be encoded in the “Storage Block” address provided by the SAC to the SMW. The SAC informs the maximum number of Data Access Units (DAU) for each Storage Block when providing it to the SMW. DAU may include a fixed number of Logical Block Addresses. The maximum number of DAU per “Storage Block” may be fixed per PSD, but may vary across them in some embodiments.

If the SMW provides a block identifier (“Blk ID”) when requesting a SAC-Block from the SAC and the SMW refers to this number on subsequent accesses, various lookup and error handling issues may be simplified on each side. For instance, both may agree on the connection and either key the Blk_ID or the SAC-Block could be used for keeping the state of writes presently underway. If a Blk_ID disagrees with the SAC-Block assigned to this Blk_D, an error condition can immediately be identified. As the number of “Storage Blocks” concurrently being written by an SMW to a SAC may typically be a small fraction of the total number of “Storage Blocks” within all PSD on a SAC, a table sized for the number of Storage Blocks being concurrently written would be materially smaller than one sized for all Storage Blocks in a SAC.

If the “Blk_ID” is eliminated from the handshake, the SMW would maintain the state of all “Storage Blocks” which are currently being written to on a SAC, and the SAC will keep state for all “Storage Blocks” which are being written from a given SMW.

A PSD-Blk_ID may be used to identify PSD-Blocks currently being written between the SAC and the PSD using the same approach as a Blk_ID is used to facilitate identification of a SAC-Block between the SMW and the SAC.

In either case (Blk_ID/PSD_Blk ID used or not), the “Storage Blocks” may be written in order of the number of Data Access Units (DAU) from the SMW to the SAC and from the SAC to the PSD.

The SAC may not be required to request a “Storage Block” from a PSD. The “Storage Blocks” inside a PSD can be detected and managed by a SAC as the amount of usable “Storage Blocks” in the PSD. Consumer-class storage devices may include a fixed amount of storage that is presented externally, with additional Storage Blocks maintained internally for management of wear across blocks and mapping out any potential blocks that are known to have failed.

When an SMW has a “Storage Block” from a SAC, it can write the DAU in sequence. A SAC may typically write in sequence, with an acknowledgement (ACK) for each write when the data is persistently stored before a subsequent write is provided to that Storage Block.

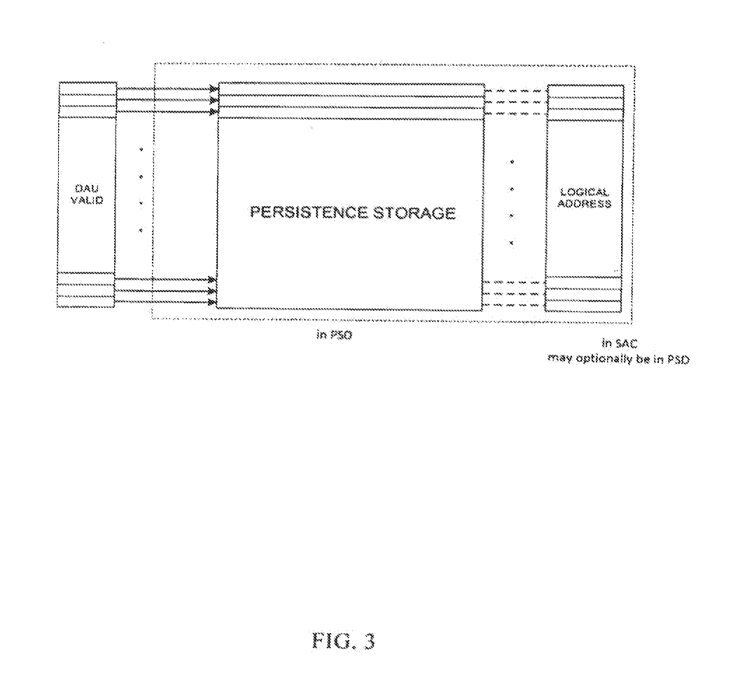

When writing a DAU, the logical address of the DAU is stored in The Media associated with the Storage Block in which the DAU is stored. (see, for example, FIG. 3). A timestamp recording when the SMW performed a write may also be placed in The Media. This timestamp may be on the order of seconds or even tens of minutes, as its optional usage is facilitating Garbage Collection.

Some embodiments of The Media, including 3 bit per cell flash memory devices require a particular set of data to be written before which earlier data may not be read back. To support this, a set of writes may be concurrently underway to a single PSD that may be acknowledged out of the order they were committed in (as long as the data may be correctly read).

Once a “Storage Block” is written in its entirety, the SMW can request a new “Storage Block”, using the same “Blk_ID”. Upon the completion of a Storage Block being entirely written, the Storage Block may become a candidate that can be subject to the Garbage Collection process (as described in more detail below).

In some embodiments, data written by a SMW to a SAC can use the “Storage Block” as upper address bits and the DAU offset as the lower address bits in the “Logical to Physical Table” which it maintains for data it has written to the SAC,

When a plurality of SMW are concurrently connected to a SAC, a “Storage Block” that is provided to one SMW may be provided for writing by that SMW and no other SMW. This may enable any SMW that has been provided a “Storage Block” to write the block without regard to write behavior of any other SMW.

According to some embodiments, any mechanism whereby a Storage Block is provided to one SMW whereby another SMW maintains a backup copy of any critical state, there is only one SMW that should write to the Storage Block at any point in time.

### Selection of Free Blocks by SAC

When a SMW requests a Storage Block from the SAC, the SAC selects among the blocks which presently have no valid data to provide to the SMW requestors. If the SAC has no available Storage Blocks at the time of the request, it may acknowledge the request while confirming that it is unable to fulfill the request at this time. Some embodiments may either have the SMW periodically attempt to acquire Storage Blocks from the SAC or have the SAC inform the SMW when it has Storage Blocks available to be used for writing.

As the SAC requires some available Storage Blocks for performing Garbage Collection, a threshold of available Storage Blocks may exist below which no Storage Blocks are provided to SMW. According to some embodiments, until such a time as a Storage Block is provided by the SAC in response to a request by the SMW, the SMW is prevented from writing DAU to the SAC.

### Reading

An SWM can retrieve DAU written to a SAC at the address it had previously been written. A read request for a DAU is sent from the SMW to the SAC. The SAC in turn determines the PSD where the actual “Storage Block” is performed and queues a request for the data to be read from the PSD.

### Freeing Unused Space on Overwrite

When a SMW has a new copy of a DAU, for example, from outside the system, which may be via a Write or invalidation message (in some embodiments this may be a SCSI UNMAP command, a SATA TRIM command or other command with similar industry generally accepted intent), or deletion of a volume that comprises many DAUs: the SMW can send a message to “invalidate” the data on a SAC.

Referring to FIG. 3, when an invalidate message is received by the SAC, it may update the DAU valid record to indicate the DAU is no longer valid. The DAU valid record may be maintained on the SAC such that no PSD becomes a bottleneck, which may reduce the memory requirements on the PSD. In some embodiments, the DAU valid state may be maintained on the PSD, which may require a message be sent between the SAC and the PSD to update this state.

A SMW can write the new copy of a DAU to persistent storage in the same SAC or a different SAC at any point after it has received an updated copy. In the event the new DAU is received into a cache of a SMW, the DAU may in fact be over-written while it is in a cache of a SMW before the data is written from the SMW to a SAC. According to some embodiment, a SMW can write a DAU to any SAC to which it is connected.

### Garbage Collection

Garbage Collection may include a process by which a DAU which no longer has valid usage may be compacted from Storage Blocks that have DAU which still have valid usage. Given the Erase-before-Write characteristics of The Media, valid DAU may be moved to a new location in order to free up space left by invalid DAU.

To perform a Garbage Collection process, the SAC may use one or more available Storage Blocks which it uses for its own Garbage Collection process, which may be referred to as the “Compacting Storage Block.”

To perform the Garbage Collection, the SAC may select among Storage Blocks which have been fully written (by either SMW or the SAC as part of a previous Garbage Collection process). If the DAU valid state for all PSDs managed by a SAC is maintained in the SAC, it can select a Storage Block directly. If the DAU valid state is kept on the PSDs and not the SAC, the SAC can request each PSD provide candidates for Garbage Collection. Candidates for Garbage Collection (by either the SAC or the PSD) can include the ratio of valid to total DAU and can optionally include the relative age of data written into the DAU in each block (if a timestamp is written with the DAU in The Media). The Storage Block chosen for Garbage Collection may be referred to herein as the “Origin Storage Block.”

Once an Origin Storage Block is selected for Garbage Collection by the SAC, the Logical Address of each valid DAU may be read and provided to the SMW which originally wrote the DAU. The SMW can (a) denote that the DAU is not valid, (b) request that the DAU be read to it in lieu of being Garbage Collected, once the read to the SMW is confirmed, the SMW can mark the DAU as invalid, and/or (c) confirm the DAU is valid and can be Garbage Collected by the SAC. Option (b) may be processed by a Read and an invalidate process, or a combined process.

If the SAC performs the Garbage Collection process, the SAC reads the DAU from Origin Storage Block in the PSD and writes the DAU into a new location in a Compacting Storage Block (for instance, in the same or a different PSD). When the DAU has been written to a Compacting Storage Block, the SAC informs the SMW that the DAU at the Logical Address originally written by the SMW which was previously in the Origin Storage Block is now stored at the new location in the Compacting Storage Block.

Until the SAC has received the acknowledgement of the move from the original Storage Block to the Compacting Storage Block, the SMW may send either Read or Invalidate messages for the DAU at the original Storage Block. Invalidate messages should be applied to both the old and new location. Reads could in fact be serviced by the original location until such point as the original Storage Block is Erased. When the SAC has received the acknowledgement of the move from the original Storage Block to the Compacting Storage Block, the SAC can mark the DAU location as invalid.

When all DAU of an Origin Storage Block are invalidated (through SMW invalidates or Garbage Collection movements by the SAC), the Storage Block can be Erased at anytime. Upon the Storage Block being erased, the SAC should record that the Storage Block is available to be provided by the SAC to any SMW (or the SAC itself for internal Garbage Collection purposes).

A case of a Storage Block wherein all DAU have been invalidated by SMW exists. In this case, the Storage Block was constructively ‘Garbage Collected’ and can be Erased at any time as if it had been Garbage Collected by the SAC.

As the SAC is writing the Compacting Storage Block, Origin Storage Blocks which were originally written by any SMW (or an earlier Garbage Collection process by the SAC) can be compacted into a common Compacting Storage Block

In the aforementioned descriptions, should a SMW be a node coordinating Read, Write, and Invalidate messages for either its own purposes or the purposes of a set of nodes which collectively hold data in a cache structure, potentially protected via a RAID (Redundant Array of Inexpensive Devices) structure, the Storage Translation Layer may remain enabled.

1. A data storage system configured to implement a storage translation layer, the system comprising:
a plurality of persistent storage devices, each of the plurality of persistent storage devices comprising storage media configured to store a plurality of data access units and metadata, and a storage device controller configured to manage a plurality of storage blocks of the storage media at a storage block level;
a plurality of storage aggregation controllers in operable communication with the plurality of persistent storage devices, the plurality of storage aggregation controllers being configured to maintain a validity of the plurality of data access units; and
a storage management writer controller in operable communication with the plurality of storage aggregation controllers, the storage management writer controller being configured to:
access logical addresses of the plurality of data access units and data stored in the plurality of persistent storage devices, and
maintain a map between the logical addresses and the data stored in the plurality of storage aggregation controllers.

2. A data storage system configured to implement a storage translation layer, the system comprising:
a plurality of persistent storage devices, each of the plurality of persistent storage devices comprising storage media configured to store a plurality of data access units and metadata, and a storage device controller configured to manage a plurality of storage blocks of the storage media at a storage block level;
a plurality of storage aggregation controllers in operable communication with the plurality of persistent storage devices, the plurality of storage aggregation controllers being configured to maintain a validity of the plurality of data access units; and
at least one storage management writer in operable communication with the plurality of storage aggregation controllers, the at least one storage management writer being configured to:
maintain a map between logical addresses and physical addresses of data access units stored in the plurality of storage aggregation controllers, and
read data from the data access units and write data to the data access units using the physical addresses.

3. The system of claim 2, wherein the plurality of storage aggregation controllers are configured to track a validity of the plurality of data access units based on messages received from the at least one storage management writer.

4. The system of claim 2, wherein the plurality of storage aggregation controllers are configured to select at least one of the plurality of storage blocks for garbage collection.

5. (canceled)

6. The system of claim 4, wherein garbage collection comprises the plurality of storage aggregation controllers selecting among storage blocks which have been fully written as part of a previous garbage collection process.

7. The system of claim 4, wherein garbage collection comprises the plurality of storage aggregation controllers selecting storage blocks for garbage collection based on a data access unit valid state for the persistent storage devices, data access unit valid state being managed by a storage aggregation controller.

8. The system of claim 4, wherein garbage collection comprises the plurality of storage aggregation controllers requesting each persistent storage device to provide at least one storage block as a candidates for garbage collection to the plurality of storage aggregation controllers.

9. The system of claim 4, wherein garbage collection comprises the plurality of storage aggregation controllers, having selected a storage block for garbage collection, reading and providing to a storage management writer the logical addresses of each valid data access unit in the storage block.

10. The system of claim 4, wherein performing garbage collection comprises sending a logical address and a physical address of a block to be garbage collected to the at least one of the plurality of storage aggregation controllers.

11. The system of claim 4, wherein the plurality of storage aggregation controllers are configured to:
read the data access unit from a first storage block in the persistent storage device, and
write the data access unit into a new location in a second storage block,
wherein, responsive to the data access unit having been written to the second storage block, the plurality of storage aggregation controllers being configured to inform the storage management writer that the data access unit at a logical address originally written by the storage management writer which was previously in the first storage block is stored at the new location in the second storage block.

12. The system of claim 11, the second storage block is in the same persistent storage device as the first storage block.

13. The system of claim 11, wherein the second storage block is in a persistent storage device other than that of the first storage block.

14. The system of claim 13, wherein the storage management writer is configured to send at least one of read or invalidate messages for the data access unit at the first storage block to the plurality of storage aggregation controllers until the plurality of storage aggregation controllers has received the acknowledgement of a move from the first storage block to the second storage block.

15. The system of claim 14, wherein the invalidate messages are applied to both the old location and the new location.

16. The system of claim 14, wherein read messages are serviced from the old location until the first storage block is erased.

17. The system of claim 14, wherein the plurality of storage aggregation controllers are configured to mark the data access unit location as invalid until the plurality of storage aggregation controllers have received an acknowledgement of a move from the first storage block to the second storage block.

18-21. (canceled)

22. The system of claim 2, wherein the storage translation layer enables a most active meta-data, wherein the meta-data comprises at least the mapping of the physical address in which data access units are stored to be maintained on the at least one storage management writer.

23. (canceled)

24. The system of claim 2, wherein each of the plurality of persistent storage devices are configured to maintain block mapping at a unit of at least one physical unit of the storage media and the plurality of storage aggregation controllers are configured to maintain physical unit level visibility into operations of the plurality of physical storage devices.

25-31. (canceled)

32. The system of claim 2, wherein at least one of an identity and a location of a physical storage device is encoded in an address of a storage block provided to the storage management writer by the plurality of storage aggregation controllers.

33-35. (canceled)

36. The system of claim 2, wherein the at least one storage management writer provides a block identifier when requesting a storage aggregation controller block from the plurality of storage aggregation controllers,
wherein the at least one storage management writer is configured to use the block identifier on subsequent accesses.

37. The system of claim 36, wherein the at least one storage management writer and the plurality of storage aggregation controllers share the identity of a state of storage blocks being actively written.

38. (canceled)

39. The system of claim 2, wherein the plurality of storage aggregation controller provides a block identifier when requesting a storage block from the persistent storage device and the plurality of storage aggregation controllers use the block identifier on subsequent accesses.

40. The system of claim 39, wherein the persistent storage device and the plurality of storage aggregation controllers share the identity of and maintain the state of storage blocks being actively written.

41. The system of claim 39, wherein the plurality of storage aggregation controllers are configured to maintain a state of all storage blocks being actively written on a persistent storage device,
wherein the persistent storage device maintains the state for all storage blocks being actively written from one of the plurality of storage aggregation controllers.

42. (canceled)

43. The system of claim 2, wherein the logical address of a data access unit being written by the at least one storage management writer is stored in the storage media associated with the storage block in which the data access unit is being written.

44-56. (canceled)

57. The system of claim 2, wherein the at least one storage management writer is configured to coordinate read, write, and invalidate messages.

58. The system of claim 2, wherein the at least one storage management writer is configured to coordinate read, write, and invalidate messages for a plurality of nodes storing data in a separate structure.

59. The system of claim 58, wherein the separate structure is a cache structure.

60. The system of claim 59, wherein the separate structure is protected via a redundant array of inexpensive devices configuration.
